(19) United States
(12) Patent Application Publication
(10) Pub. No.: US 2015/0029414 A1
(43) Pub. Date: Jan. 29, 2015

(54) TOUCH SENSOR

(71) Applicant: SAMSUNG ELECTRO-MECHANICS CO., LTD., Suwon-si (KR)

(72) Inventors: Kang Heon HUR, Suwon-si (KR); Dae Ho KIM, Suwon-si (KR); Tae Kyung LEE, Suwon-si (KR); Kyu Sang LEE, Suwon-si (KR)

(73) Assignee: SAMSUNG ELECTRO-MECHANICS CO., LTD., Suwon-si (KR)

(21) Appl. No.: 14/196,245

(22) Filed: Mar. 4, 2014

(30) Foreign Application Priority Data
Jul. 29, 2013 (KR) 10-2013-0089591

(51) Int. Cl. G06F 3/041

(52) U.S. Cl. CPC G06F 3/041
USPC 349/12

(57) ABSTRACT

Disclosed herein is a touch sensor including a window substrate, a bezel layer formed on an edge part of the window substrate, a reflective layer formed on the bezel layer, and electrode patterns formed in the bezel layer of the window substrate, wherein the bezel layer is formed of a transparent material. Thus, due to the formation of the bezel layer and the reflective layer of the touch sensor, bezel colors are effectively realized using a more thinned film bezel.

### CROSS REFERENCE TO RELATED APPLICATION

This application claims the benefit of Korean Patent Application No. 10-2013-0089591, filed on Jul. 29, 2013, entitled “Touch Sensor”, which is hereby incorporated by reference in its entirety into this application.

### BACKGROUND OF THE INVENTION

1. Technical Field

The present invention relates to a touch sensor.

2. Description of the Related Art

As computers using digital technologies have been developed, auxiliary equipment of computers has correspondingly been developed together. A personal computer, a portable transmitting apparatus, or other personal information processing apparatuses perform text and graphic processes by using various input devices such as keyboards, mouse, and the like.

However, along with the rapid development of an information-oriented society, computers have been widely used, and thus, it is difficult to effectively drive a product by using only a keyboard and a mouse, which presently function as an input device. Accordingly, there is an increasing need for a device to which anyone can easily input information via a simple method without causing an erroneous operation.

Technologies for input devices have exceeded the standard for providing general functions and interest in input devices has changed toward high reliability, high durability, high innovation, design and process-related technologies. To this end, a touch sensor has been developed as an input device for inputting information such as text, graphic, and so on.

A touch sensor is a device that is installed on a display surface of a flat display apparatus such as an electronic notebook, a liquid crystal display device (LCD), a plasma display panel (PDP), or electroluminescence (EL) or a display surface of an image displaying apparatus such as a cathode ray tube (CRT) and is used for a user to select desired information while watching the image displaying apparatus.

A touch sensor is classified into a resistive type touch sensor, a capacitive type touch sensor, an electro-magnetic type touch sensor, a surface acoustic wave (SAW) type touch sensor, and an infrared type touch sensor. Such various types of touch sensors are used in electronic products in consideration of issues of signal amplification, a resolution difference, difficulty in design and process technologies, optical properties, electrical properties, mechanical properties, environmental properties, input properties, durability, and economic feasibility. Currently, from among various types of touch sensors, a resistive type touch sensor and a capacitive type touch sensor have been most commonly used.

As an example of this touch sensor, the touch sensor may be configured in such a way that a transparent substrate and a detector are adhered via an adhesive agent and a bezel part formed along an edge of the transparent substrate hides a bus line of the detector, as disclosed in Cited Reference below.

Recently, an outer design of intellectual technology (IT) devices has become very important and display screens have been increased. Efforts are underway to increase a display screen without increasing an outer size of a device to reduce a thickness as an area of a bezel part in order to realize full color close to original color of an actual object.

However, the area or thickness of the bezel part may vary according to color of a target bezel part. In particular, in case of bright tone color through which light is easily transmitted, such as white, the thickness of the bezel part is inevitably increased in order to minimize transmittance of light, which is against the trend of miniaturized and slimmed IT devices.

### PRIOR ART DOCUMENT

### Patent Document

(Patent Document 1) Korean Patent Laid-Open Publication No. KR2011-0053940 A

### SUMMARY OF THE INVENTION

The present invention has been made in an effort to provide a touch sensor for effectively realizing color of the bezel layer using only a thin film by forming the transparent bezel layer and a reflective layer formed on the bezel layer and for improving driving performance and operative reliability of the touch sensor by reducing a step difference of a bezel layer.

According to an embodiment of the present invention, there is provided a touch sensor including a window substrate, a bezel layer formed on an edge part of the window substrate, and a reflective layer formed on the bezel layer, wherein the bezel layer is formed of a transparent material.

The bezel layer may be formed to have a visible region refractive index of 1.9 to 4.

The bezel layer may be formed to have visible region transmittance of 50% to 99%.

A stack direction thickness of the bezel layer may be 30 nm to 500 nm.

The bezel layer may be formed to have a visible region refractive index of 1.6 to 1.9.

The bezel layer may be formed to have visible region transmittance of 40% to 60%.

The bezel layer may be formed to a stack direction thickness of 10 nm to 1000 nm.

The bezel layer may be formed of TiO₂, Al₂O₃, SiO₂, HfO₂, or a combination thereof.

The bezel layer may be formed of ZnO, MgO, Ce2O₃, In₂O₃, ITO, BaTiO₃, (Ba, Sr)TiO₃, KTaO₃, or a combination thereof.

The reflective layer may be formed to have visible region reflectivity of 20% to 99%.

The reflective layer may be formed to have visible region reflectivity of 30% to 99%.

The reflective layer may be formed of titanium (Ti), aluminum (Al), nickel (Ni), silver (Ag), chrome (Cr), platinum (Pt), molybdenum (Mo), or a combination thereof.

The reflective layer may be formed of copper (Cu), gold (Au), tungsten (W), iridium (Ir), or a combination thereof.

The touch sensor may further include electrode patterns formed in the bezel layer of the window substrate, an insulating layer formed on the reflective layer, and electrode wirings electrically connected from the electrode patterns and formed on the insulating layer.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a cross-sectional view of a window substrate on which a bezel layer is formed according to an embodiment of the present invention;

FIG. 2 is a cross-sectional view of a touch sensor according to an embodiment of the present invention;

FIG. 3 is a cross-sectional view of a touch sensor according to another embodiment of the present invention;

FIG. 4 is a partially enlarged view of the bezel layer according to an embodiment of the present invention; and

FIG. 5 is a diagram illustrating the L*a*b* color system.

### DESCRIPTION OF THE PREFERRED EMBODIMENTS

The objects, features, and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side”, and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, the present invention will be described in detail by explaining exemplary embodiments of the invention with reference to the attached drawings.

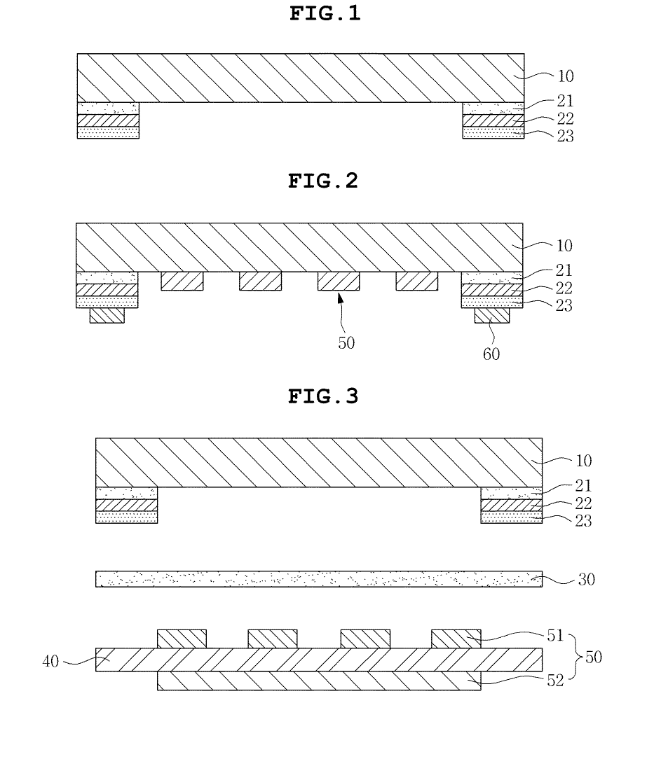

FIG. 1 is a cross-sectional view of a window substrate 10 on which a bezel layer 21 is formed according to an embodiment of the present invention. FIG. 2 is a cross-sectional view of a touch sensor according to an embodiment of the present invention.

The touch sensor according to the present embodiment may include the window substrate 10, the bezel layer 21 formed on an edge part of the window substrate 10, and a reflective layer 22 formed on the bezel layer 21. The bezel layer 21 may be formed of a transparent material.

The window substrate 10 is formed on an outermost portion of the touch sensor to protect the touch sensor from an external environment. For user visibility, the window substrate 10 may be formed of a transparent material, for example, glass or tempered glass. The window substrate 10 may be formed of any material as long as the material has predetermined rigidity or more. According to an embodiment of the present invention, electrode patterns 50 together with the bezel layer 21 formed directly on the window substrate 10 are formed on the window substrate 10, thereby improving touch sensitivity as well as obtaining a slimmed and miniaturized touch sensor. However, in addition to the structure in which the electrode patterns 50 are formed directly on the window substrate 10, it is obvious to one of ordinary skill in the art to select and apply various structures of a touch sensor formed by forming the electrode patterns 50 on a separate base substrate 40 and combining the window substrate 10 and the base substrate 40.

The bezel layer 21 may be formed on the edge part of the window substrate 10. The bezel layer 21 may be formed to indicate a logo or the like on a screen region of the touch sensor or to hide electrode wirings of opposite ends that are electrically connected on the electrode patterns 50. The bezel layer 21 may realize various colors in various devices including the touch sensor, thereby improving outer properties as well as increasing the visibility of the electrode wirings and electrical reliability of the touch sensor. In order to realize various colors of the bezel layer 21, even though a required bezel layer is changed according to a material thereof, the bezel layer 21 with a greater thickness is required in order to realize bright color such as white, in general. When light is completely transmitted through the bezel layer 21, it is difficult to recognize color of the bezel layer 21 by a user. Thus, in order to embody the bezel layer 21 having color such as white, the bezel layer 21 needs to have a great thickness unlike in a case for realizing other color through which light is barely transmitted.

However, a transparent thin film is used, a refractive index and transmittance are adjusted, and the bezel layer 21 includes the reflective layer 22 formed on one surface thereof, and thus, the bezel layer 21 according to the present embodiment may effectively and clearly realize color of the bezel layer 21 compared with a case in which the bezel layer 21 is formed in the form of thin film. In addition, when a thin film type material is used, reliability of a method of forming a bezel layer, such as sputtering may be increased. The bezel layer 21 will be described below in detail.

The touch sensor according to the present embodiment is of a window integration type, as illustrated in FIG. 2. Thus, the electrode patterns 50 may be a pattern directly on the window substrate 10. Here, the window integration type refers to a structure in which the electrode patterns 50 are formed directly on the window substrate 10 or a structure in which the electrode patterns 50 are formed directly on the window substrate 10 on which an additional function layer such as a separate adhesive layer is formed on the window substrate 10. The structure of the touch sensor according to the embodiment of the present invention is not particularly limited to the structure of the diagrams.

The electrode patterns 50 generate a signal via a touch input element and recognize touch coordinates from a controller (not shown). In order to electrically connect the electrode patterns 50, electrode wirings 60 may be connected onto the bezel layer 21. As described above, as the more slimmed bezel layer 21 may realize color, a step difference between the electrode patterns 50 and the electrode wirings 60 may be relieved in the window integration type, thereby obtaining a more reliable touch sensor.

The electrode patterns 50 may be formed in mesh patterns using copper (Cu), aluminum (Al), gold (Au), silver (Ag), titanium (Ti), palladium (Pd), chromium (Cr), nickel (Ni) or a combination thereof. The electrode patterns 50 may be formed using metal oxide such as metal Ag formed by exposing/developing a silver salt emulsion layer, indium tin oxide (ITO), or the like, or a conductive polymer that has excellent flexibility and is formed via simple coating, such as PEDOT/PSS or the like.

With regard to the electrode patterns 50 formed on the window substrate 10, the electrode patterns 50 of X and Y axes are simultaneously arranged on one layer. The electrode patterns 50 formed on the window substrate 10 in one direction are formed, and the electrode patterns 50 formed on the base substrate 40 in the other direction crossing the one direction are formed to cross the electrode patterns 50 in one direction, thereby achieving a mutual capacitance type touch sensor.

As shown in FIG. 3, according to another embodiment of the present invention, it is obvious to one of ordinary skill in the art that the touch sensor may be embodied by forming a first electrode pattern 51 and a second electrode pattern 52 to respectively cross opposite surfaces of the base substrate 40 coupled to the window substrate 10. The first electrode pattern 51 and the second electrode pattern 52 may be formed on the opposite surfaces of the base substrate 40 and may be adhered to the window substrate 10 via a transparent adhesive layer 30. Here, the base substrate 40 may be formed of a transparent material. The base substrate 40 may be formed of any material as long as the material has predetermined rigidity or more. The base substrate 40 may be formed of polyethyleneterephthalate (PET), polycarbonate (PC), polymethyl methacrylate (PMMA), polyethylenenaphthalate (PEN), polyether sulfone (PES), cyclic olefin polymer (COC), triacetylcellulose (TAC) film, or the like. A high frequency process or a primer process may be performed on one surface of the base substrate 40, thereby increasing adhesive intensity with electrode patterns. The first electrode pattern 51 and the second electrode pattern 52 are the same as the aforementioned the electrode patterns 50 in terms of a material and formation method thereof, and thus, a detailed description thereof is omitted.

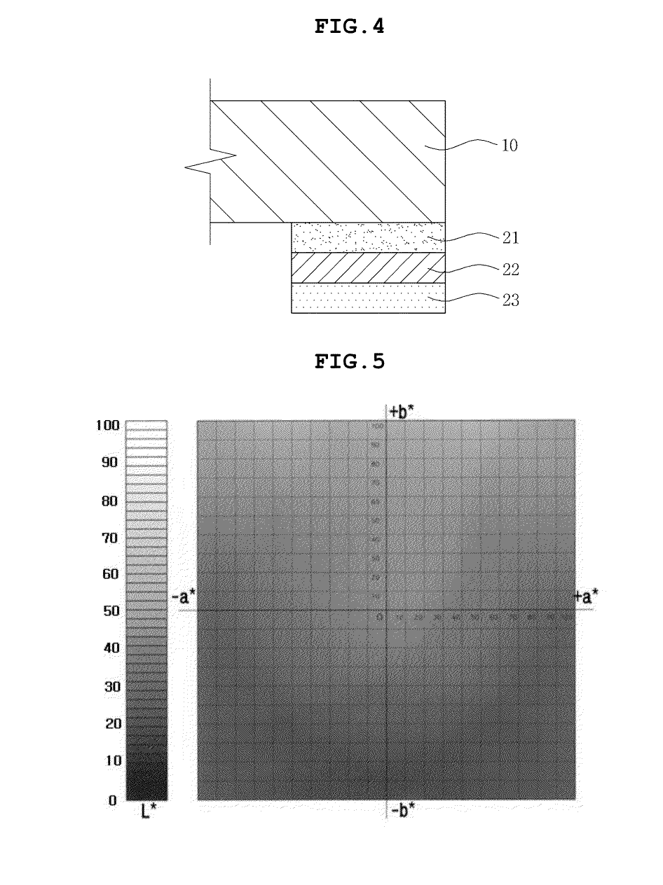

FIG. 4 is a partially enlarged view of the bezel layer 21 according to an embodiment of the present invention.

The touch sensor according to the present embodiment may include the bezel layer 21 formed on the window substrate 10 and the reflective layer 22 formed on the bezel layer 21. Here, the bezel layer 21 may not exhibit predetermined color and may be formed of a transparent layer having variables such as a refractive index, transmittance, and a thickness in a visible range. In particular, the reflective layer 22 is coupled onto the transparent bezel layer 21 to prevent light from being transmitted directly through the bezel layer 21 to realize unique color on the transparent layer according to light reflectivity.

The transparent thin film used as the bezel layer 21 may be formed to have a visible region refractive index of 1.9 to 4 or 1.6 to 1.9.

The bezel layer 21 may be formed to have visible region transmittance of 50% to 99% or 40% to 60%.

The thickness of the bezel layer 21 in a stack direction may be 30 nm to 500 nm or 10 nm to 1000 nm. In particular, as described below, various colors may be realized according to the stack direction thickness of the bezel layer 21. Of course, combinations of various colors may be realized with respect to one bezel layer 21 by using difference between stack thicknesses.

The bezel layer 21 may be formed as a transparent thin film and may be formed of titanium dioxide (TiO₂), alumnimum oxide (Al₂O₃), silicon dioxide (SiO₂), hafnium dioxide (HfO₂), or a combination thereof. Alternatively, the bezel layer 21 may be formed of zinc oxide (ZnO), magnesium oxide (MgO), cesium oxide (Ce₂O₃), indium oxide (In₂O₃), indium tin oxide (ITO), barium titanate (BaTiO₃), potassium tantalate (KTaO₃), (Ba, Sr)TiO₃, or a combination thereof.

The reflective layer 22 formed on one surface of the bezel layer 21 with the other surface coupled to the window substrate 10 scatters light transmitted through an upper portion of the window substrate 10 into the bezel layer 21 so as to easily realize color of the bezel layer 21. Reflectivity of the reflective layer 22 in a visible region may be 20% to 99% or 30% to 99%.

The reflective layer 22 may be formed of titanium (Ti), aluminum (Al), nickel (Ni), silver (Ag), chrome (Cr), platinum (Pt), molybdenum (Mo), or a combination thereof. Alternatively, reflective layer 22 may be formed of copper (Cu), gold (Au), tungsten (W), iridium (Ir), or a combination thereof. In particular, when the reflective layer 22 is formed of a metal layer, the structure of the touch sensor according to the present embodiment may further include an insulating layer 23 on the reflective layer 22 for insulation from electrode wirings (refer to FIG. 2).

According to an embodiment of the present invention, various colors may be realized by appropriate combinations of thicknesses of the bezel layer 21 and the reflective layer 22. In particular, when the bezel layer 21 is formed as a transparent thin film, the bezel layer 21 with high reliability may be formed via a deposition process during manufacturing processes as well as may be slimmed.

TABLE 1

| | Bezel layer | | Reflective layer | | |
|---|---|---|---|---|---|
| Sample | Material | Thickness | Material | Thickness | Color |
| 1 | TiO₂ | 50 nm | Ti | 200 nm | L* = 40.67, a* = 9.16, b* = 3.74 (113R, |
| | | | | | 91G, 90B): lilas color |
| 2 | TiO₂ | 80 nm | Ti | 200 nm | L* = 49.71, a* = −0.46, b* = −23.82 (90R, |
| | | | | | 120G, 158B): blue |
| 3 | TiO₂ | 120 nm | Ti | 200 nm | L* = 65.85, a* = −6.42, b* = −8.91 (138R, |
| | | | | | 164G, 175B): light sky blue |
| 4 | TiO₂ | 150 nm | Ti | 400 nm | L* = 69.59, a* = −4.82, b* = −29.14 (180R, |
| | | | | | 171G, 116B): light green |
| 5 | TiO₂ | 150 nm | Al | 400 nm | L* = 92.05, a* = −4.08, b* = 3.13 (227R, |
| | | | | | 234G, 226B): bright silver color |
| 6 | TiO₂ | 170 nm | Al | 400 nm | L* = 93.75, a* = −3.00, b* = 1.31 (232R, |
| | | | | | 239G, 234B): bright silver color |

As seen from Table 1 above, color of the bezel layer 21 is realized in various forms shown in a right part via combinations of the thicknesses of the bezel layer 21 and the reflective layer 22. The realized color table may refer to a color table illustrated in FIG. 5.

The L*a*b* color system (refer to FIG. 5) is made to represent color errors and slight color differences in terms of pigment industrial fields, paint, paper, plastic, fabric, and so on. As a research result for more approaching to human sensitivity, the L*a*b* color system is made based on the opponent color theory between yellow and blue and between green and red which are colors detected by human and one of color spaces defined by CIE on 1976. In the L*a*b* color system, L* represents brightness and a* and b* represent color directions, as coordinates of FIG. 5. That is, +a* represents a red direction, −a represents a green direction, +b* represents a yellow direction, and −b* represents a blue direction. A center represents an achromatic color. As values of a* and b* are increased outwards from the center, chroma is increased. When color mixing is performed based on the features of this color system, color errors are easily represented and color conversion directions are easily assumed, and thus, the color system is widely used around the world.

First, sample 1 corresponds to an experiment result obtained in a case in which a stack direction thickness of TiO₂ is 50 nm and Ti is added to the reflective layer 22 to a thickness 200 nm. In the color system of FIG. 5, lilas color represented by L*=40.67, a*=9.16, and b*=3.74 may be realized. Sample 2 corresponds to an experiment result obtained in a case in which a stack direction thickness of TiO₂ is 80 nm and Ti is added to the reflective layer 22 to a thickness 200 nm. In this case, blue represented by L*=49.71, a*=−0.46, and b*=−23.82 may be realized. Sample 3 corresponds to an experiment result obtained in a case in which a stack direction thickness of TiO₂ is 120 nm and Ti is added to the reflective layer 22 to a thickness 200 nm. In this case, light sky blue represented by L*=65.85, a*=−6.42, and b*=−8.91 may be realized. Sample 4 corresponds to an experiment result obtained in a case in which a stack direction thickness of TiO₂ is 150 nm and Ti is added to the reflective layer 22 to a thickness of 400 nm. In this case, light green represented by L*=69.59, a*=−4.82, and b*=−29.1 may be realized.

Sample 5 corresponds to an experiment result obtained in a case in which a stack direction thickness of TiO₂ is 150 nm and Al is added to the reflective layer 22 to a thickness of 400 nm. In this case, bright silver color represented by L*=92.05, a*=−4.08, and b*=3.13 may be realized. Sample 6 corresponds to an experiment result obtained in a case in which TiO₂ is added to the reflective layer 22 with the same material and thickness to a thickness of 170 nm. In this case, bright silver color represented by L*=93.75, a*=−3.00, and b*=1.31 may be realized.

In addition, based on the above color change according to change in the thickness of the bezel layer 21, by changing the stack direction thickness of at least one transparent bezel layer 21, for example, the aforementioned thin film formed of TiO₂, a logo may be printed on the window substrate 10 or a related design with excellent aesthetics may be obtained, and various colors may be easily combined.

According to the present invention, a bezel layer and a reflective layer of a touch sensor are stacked together, and thus, colors may be effectively realized using the bezel layer in the form of a more thinned film.

The bezel layer is formed of a transparent layer with a constant refractive index and transmittance and the reflective layer is formed on the transparent layer, and thus, color that is difficult to realize using only a thin film, such as white and so on may be more effectively realized.

As the bezel layer is thinned, in a window integration type touch sensor structure in which electrode patterns are formed on a window substrate including the bezel layer, electrical short circuits due to a step difference between the electrode patterns and electrode wirings may be prevented, and thus, the touch sensor may be more stably operated.

In addition to a coupling structure of a reflective layer coupled to a transparent layer applied as the bezel layer, by adjusting a coupling thickness of the transparent layer and the reflective layer, more various and clear colors of the bezel layer may be realized.

By applying a thin film used as the transparent layer to the bezel layer, various colors may be simultaneously realized according to a stack layer of stacked bezel layers so as to realize a logo or other desired shape.

In addition, by selecting a thin film type material for forming the bezel layer formed on the window substrate, the touch sensor may be easily manufacture to reduce manufacturing errors and to improve manufacturing reliability, while increasing production efficiency.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations, or equivalent arrangements should be considered to be within the scope of the invention, and the detailed scope of the invention will be disclosed by the accompanying claims.

What is claimed is:

1. A touch sensor, comprising:
a window substrate;
a bezel layer formed on an edge part of the window substrate; and
a reflective layer formed on the bezel layer,
wherein the bezel layer is formed of a transparent material.

2. The touch sensor as set forth in claim 1, wherein the bezel layer is formed to have a visible region refractive index of 1.9 to 4.

3. The touch sensor as set forth in claim 1, wherein the bezel layer is formed to have visible region transmittance of 50% to 99%.

4. The touch sensor as set forth in claim 1, wherein a stack direction thickness of the bezel layer is 30 nm to 500 nm.

5. The touch sensor as set forth in claim 1, wherein the bezel layer is formed to have a visible region refractive index of 1.6 to 1.9.

6. The touch sensor as set forth in claim 1, wherein the bezel layer is formed to have visible region transmittance of 40% to 60%.

7. The touch sensor as set forth in claim 1, wherein the bezel layer is formed to a stack direction thickness of 10 nm to 1000 nm.

8. The touch sensor as set forth in claim 1, wherein the bezel layer is formed of TiO₂, Al₂O₃, SiO₂, HfO₂, or a combination thereof.

9. The touch sensor as set forth in claim 1, wherein the bezel layer is formed of ZnO, MgO, Ce2O₃, In₂O₃, ITO, BaTiO₃, (Ba, Sr)TiO₃, KTaO₃, or a combination thereof.

10. The touch sensor as set forth in claim 1, wherein the reflective layer is formed to have visible region reflectivity of 20% to 99%.

11. The touch sensor as set forth in claim 10, wherein the reflective layer is formed to have visible region reflectivity of 30% to 99%.

12. The touch sensor as set forth in claim 1, wherein the reflective layer is formed of titanium (Ti), aluminum (Al), nickel (Ni), silver (Ag), chrome (Cr), platinum (Pt), molybdenum (Mo), or a combination thereof.

13. The touch sensor as set forth in claim 1, wherein the reflective layer is formed of copper (Cu), gold (Au), tungsten (W), iridium (Ir), or a combination thereof.

14. The touch sensor as set forth in claim 1, further comprising:
electrode patterns formed in the bezel layer of the window substrate;
an insulating layer formed on the reflective layer; and
electrode wirings electrically connected from the electrode patterns and formed on the insulating layer.
